(19) United States
(12) Patent Application Publication
(10) Pub. No.: US 2026/0146919 A1
(43) Pub. Date: May 28, 2026

(54) TIRE-BASED SCALE CALIBRATION WITH GEOMETRIC COMPENSATION AND REAL-TIME ADAPTIVE PROCESSING

(71) Applicant: UVeye Ltd., Tel Aviv (IL)

(72) Inventors: Amir HEVER, Tenafly, NJ (US); Tamir ABUTBUL, Rishon Le Zion (IL); Roi NACHMANI, Petach Tikva (IL); Ron Shmuel SUDAR, Netanya (IL); Guy ENGEL, Herzliya (IL)

(73) Assignee: UVeye Ltd., Tel Aviv (IL)

(21) Appl. No.: 19/346,678

(22) Filed: Oct. 1, 2025

Related U.S. Application Data
(63) Continuation-in-part of application No. 18/957,776, filed on Nov. 24, 2024.

(51) Int. Cl. G01M 17/02; G06T 5/80; G06T 7/00; G06T 7/12; G06T 7/62; G06V 10/141; G06V 20/62

(52) U.S. Cl. CPC G01M 17/027; G06T 5/80; G06T 7/0006; G06T 7/12; G06T 7/62; G06V 10/141; G06V 20/62

(57) ABSTRACT

A computerized system for calibrating vehicle part measurements utilizes tire-based scale calibration with image processing and geometric compensation capabilities. The system automatically determines estimated tire size data from tire images using consensus-based algorithms, extracts actual tire specifications through optical character recognition, and calculates scale calibration data for converting pixel measurements to physical units. Geometric distortion detection and compensation handle angular misalignments between camera and tire planes. Real-time continuous calibration adapts to changing conditions during vehicle inspection operations. The calibration data integrates with defect detection and severity classification systems to enable accurate physical measurements of vehicle components and defects, providing calibration accuracy within 2% across varying operating conditions while accommodating diverse tire types and operational scenarios.

### RELATED APPLICATIONS

This application is a Continuation-In-Part (CIP) of U.S. patent application Ser. No. 18/957,776 filed on Nov. 24, 2024, the contents of which are all incorporated by reference as if fully set forth herein in its entirety.

### FIELD AND BACKGROUND OF THE INVENTION

The presently disclosed subject matter relates to computerized systems and methods for calibrating measurements in vehicle inspection systems with unprecedented accuracy and reliability under real-world operating conditions. More particularly, the disclosure relates to automatic scale calibration systems that utilize tire-based reference measurements with image processing techniques, geometric distortion compensation, consensus-based tire analysis, and real-time calibration updates to enable precise physical measurements of vehicle components and defects that meet the demanding accuracy requirements of modern automotive inspection applications.

Vehicle inspection systems increasingly rely on computer vision techniques to detect, classify, and measure defects such as dents, scratches, paint damage, rust, clearcoat damage, and tire wear with precision that directly impacts safety assessments, warranty determinations, and quality control decisions. A critical challenge in these systems involves converting pixel-based measurements from digital images into accurate physical dimensions expressed in standard length units such as millimeters or inches, where measurement errors can have significant consequences for both safety evaluations and commercial decisions.

Without proper scale calibration that remains accurate under varying operational conditions, inspection systems cannot reliably determine whether detected defects exceed severity thresholds that trigger repair recommendations, warranty claims, or safety alerts. The fundamental challenge extends beyond simple pixel-to-physical unit conversion to encompass maintaining calibration accuracy despite environmental variations, equipment positioning constraints, and operational factors that affect measurement precision throughout extended inspection sessions.

### SUMMARY OF THE INVENTION

In accordance with certain aspects of the presently disclosed subject matter, there is provided a computerized system for calibrating vehicle part measurements that solves the technical problems described above through several coordinated innovations that work together synergistically to achieve superior calibration accuracy and reliability under real-world operating conditions that would defeat conventional approaches.

The system comprises an interface configured for obtaining images of vehicle tires within an inspection area using imaging devices, and one or more processors configured to perform calibration operations that overcome the fundamental limitations of conventional approaches through systematic application of multiple complementary technical innovations that address different aspects of the calibration challenge ly.

The processors automatically determine estimated tire size data from tire images using computer vision techniques specifically designed to extract accurate dimensional information even under challenging visual conditions that would defeat simpler approaches commonly used in conventional systems. The size determination process intelligently analyzes tire geometry through multiple coordinated techniques including automated tire boundary detection, consensus-based shape fitting algorithms, and geometric analysis that provides robust performance despite image noise, surface contamination, or partial occlusions.

The system determines scale calibration data informative of pixels to physical unit ratio based on the estimated tire size data and actual tire size data, enabling the system to calibrate measurement calculations for objects of interest within images acquired by the imaging device while the vehicle is within the inspection area. This calibration data provides the foundation for accurate physical measurements of defects, component dimensions, and other features of interest throughout the inspection process.

In optional embodiments, the system implements pressure-invariant calibration techniques by calculating tire dimensional measurements along axes that remain substantially constant despite tire pressure variations. A particularly advantageous approach involves measuring horizontal tire diameter data, where the horizontal measurement provides calibration that remains substantially constant despite tire pressure variations that would cause significant errors in conventional vertical measurement approaches. This approach leverages the physical reality that tire pressure loss primarily affects vertical tire compression due to vehicle weight loading, while horizontal tire dimensions remain substantially unchanged due to tire structural design characteristics.

Another significant technical advancement involves detecting and compensating for geometric distortions between imaging device planes and tire planes through geometric analysis that maintains measurement accuracy even when perfect alignment cannot be achieved due to practical deployment constraints. The system fits ellipses to tire portions, particularly rim sections that provide consistent circular reference geometry, and analyzes ellipse characteristics to calculate angular misalignment between camera and tire planes. When significant misalignment is detected, the system applies geometric transformations to compensate for perspective distortions in calibration calculations.

The automatic tire analysis process employs consensus-based estimation techniques, particularly RANSAC algorithms specifically adapted for tire boundary detection applications that provide superior performance compared to conventional edge detection approaches. The RANSAC implementation iteratively selects random subsets of boundary points, fits candidate geometric shapes to each subset, evaluates consensus among remaining points for each candidate shape, and selects optimal geometric parameters based on maximum consensus criteria that naturally exclude outlier points resulting from image noise, surface contamination, or partial occlusions.

embodiments integrate optical character recognition techniques specifically optimized for tire sidewall text recognition to automatically extract actual tire size data from tire specification markings. The system recognizes various tire designation formats across different vehicle types and applies mathematical relationships to convert tire specification parameters into actual dimensional data that serves as ground truth reference for calibration calculations.

The system performs calibration continuously while vehicles move through inspection areas, providing real-time scale calibration updates for dynamic vehicle inspection operations that maintain accuracy throughout extended inspection sessions. This continuous calibration capability represents a significant departure from conventional static calibration approaches, enabling the system to adapt to changing environmental conditions, equipment drift, and operational variations while maintaining measurement accuracy without requiring frequent manual intervention or system reconfiguration.

The calibration system integrates seamlessly with defect detection and severity assessment capabilities, enabling precise measurement of vehicle defects and component dimensions with accuracy suitable for critical safety and quality control applications. The system converts pixel-based measurements to physical units using the calibrated scale factors, enabling objective defect severity classification based on actual physical dimensions rather than arbitrary pixel counts.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A illustrates a schematic functional block diagram of a vehicle inspection system incorporating tire-based scale calibration with geometric compensation capabilities, real-time processing integration, and defect detection capabilities in accordance with certain embodiments of the presently disclosed subject matter;

FIG. 1B illustrates a schematic functional block diagram of a computerized calibration system with geometric compensation and real-time processing capabilities, showing the integration of multiple functional modules that work together to provide calibration and measurement capabilities in accordance with certain embodiments of the presently disclosed subject matter;

FIG. 2 depicts an exemplary tire image segment including a marked defect, demonstrating the application of calibrated measurements to defect sizing and severity assessment where accurate physical dimensions enable appropriate response decisions in accordance with certain embodiments of the presently disclosed subject matter;

FIG. 3 illustrates a generalized flow diagram of operations for determining pixels to length unit transformation with consensus-based tire segmentation and integrated geometric compensation capabilities in accordance with certain embodiments of the presently disclosed subject matter;

FIG. 4 shows an exemplary tire image segment including tire text data for automatic extraction of actual tire diameter information using optical character recognition techniques specifically optimized for tire sidewall text recognition in accordance with certain embodiments of the presently disclosed subject matter;

FIG. 5 illustrates schematically the various tire data elements derivable from tire text data, including the mathematical relationships for calculating actual tire diameter data that provide ground truth reference measurements for calibration calculations in accordance with certain embodiments of the presently disclosed subject matter;

FIG. 6 illustrates schematically a tire image after undergoing automatic segmentation and consensus-based circle estimation with dimensional measurement capabilities that provide robust calibration reference data in accordance with certain embodiments of the presently disclosed subject matter;

FIGS. 7A-B are exemplary images demonstrating tire dimensional measurement under different pressure conditions, validating the effectiveness of pressure-compensation techniques under controlled testing conditions in accordance with certain embodiments of the presently disclosed subject matter;

FIG. 8 presents a table illustrating calibration accuracy results comparing actual and calculated tire diameter data across various test conditions including different tire sizes, pressure levels, and imaging conditions in accordance with certain embodiments of the presently disclosed subject matter;

FIG. 9 illustrates a sequence of operations for calculating defect severity using calibrated measurements integrated with polygon-based defect characterization and threshold-based severity classification systems in accordance with certain embodiments of the presently disclosed subject matter; and

FIG. 10 provides a geometric analysis diagram illustrating tilt angle calculation and compensation when imaging device planes are not parallel to tire planes, including mathematical relationships and transformation techniques in accordance with certain embodiments of the presently disclosed subject matter.

### DESCRIPTION OF SPECIFIC EMBODIMENTS OF THE INVENTION

The following detailed description presents the technical innovations in a carefully structured progression that builds understanding from fundamental system architecture through processing algorithms to practical implementation considerations. The approach demonstrates how multiple coordinated innovations work together to achieve calibration accuracy and reliability that significantly exceeds conventional approaches while maintaining practical deployability in real-world inspection environments.

Traditional scale calibration approaches suffer from several technical limitations that significantly impact their practical deployment in real-world inspection environments where hundreds or thousands of vehicles may be processed daily under varying conditions. Manual calibration methods require tedious setup procedures using physical reference objects or calibration targets, making them impractical for high-throughput inspection facilities and creating operational inefficiencies that reduce system productivity while introducing potential human errors that can compromise measurement accuracy.

These manual approaches are particularly problematic because they require recalibration whenever camera positions change due to thermal expansion, mechanical vibration, or maintenance activities, and whenever lighting conditions vary due to weather changes, time-of-day effects, or facility lighting modifications. The frequency of required recalibration creates operational overhead that can significantly impact inspection throughput while introducing uncertainty about measurement accuracy between calibration sessions.

Some existing automated calibration systems attempt to use known vehicle dimensions as reference measurements, but these approaches face significant accuracy challenges that limit their practical effectiveness in demanding inspection applications. Vehicle dimensions vary considerably between manufacturers, models, and years, making reliable reference data difficult to obtain and maintain with sufficient accuracy for precision measurement applications. Additionally, many vehicle features used for calibration can be partially obscured by other vehicles, inspection equipment, or environmental factors such as dirt, water, or shadows, leading to incomplete or inaccurate reference measurements that propagate errors throughout the measurement process.

Prior attempts to use tire-based calibration have shown promise but encounter specific technical problems that prevent reliable deployment in demanding inspection applications where measurement precision directly impacts safety and quality assessments. These conventional tire-based approaches face several fundamental limitations that render them unsuitable for critical inspection applications requiring consistent accuracy under real-world operating conditions.

A primary limitation involves susceptibility to environmental and operational variations that affect tire geometry and appearance, creating systematic measurement errors that compound throughout the inspection process. Tire pressure variations due to temperature changes, slow leaks, or normal operational factors can significantly alter tire dimensions, particularly affecting vertical measurements where vehicle weight loading causes sidewall compression that changes apparent tire diameter. When tire pressure decreases, conventional measurement approaches that rely on overall tire dimensions experience accuracy degradation that makes them unreliable for precision applications.

Existing tire-based calibration systems also lack robust mechanisms for handling geometric distortions that occur when camera planes and tire planes are not perfectly parallel, a common situation in real-world inspection environments. Vehicles often enter inspection areas at slight angles due to operator variation, lane positioning constraints, or facility layout limitations, and may be positioned imperfectly relative to imaging equipment due to space constraints or mounting restrictions, creating perspective distortions that skew calibration calculations beyond acceptable tolerance limits for precision applications.

Without proper geometric compensation, these distortions propagate through all subsequent measurements, creating systematic errors that can exceed acceptable tolerance limits for precision inspection applications where measurement accuracy directly impacts safety assessments and regulatory compliance. The magnitude of these errors increases with angular misalignment, making conventional approaches particularly problematic in facilities where perfect geometric alignment cannot be maintained consistently.

Furthermore, conventional approaches lack image processing techniques for reliably extracting tire dimensional information in challenging visual conditions that commonly occur in real-world inspection environments. Factors such as varying lighting conditions from natural and artificial sources, tire wear patterns that create irregular surface characteristics, dirt accumulation from normal vehicle operation, water or oil contamination that affects surface reflectance, and partial occlusions by other objects can interfere with accurate tire detection and measurement using simple edge detection or threshold-based segmentation techniques.

These challenging visual conditions often cause simple image processing approaches to fail, leading to unreliable calibration data and subsequent measurement errors that can compromise the entire inspection process. The need for robust image processing becomes particularly critical in industrial environments where perfect imaging conditions cannot be guaranteed and where system reliability must be maintained despite environmental variations.

Current systems typically perform calibration as a separate, static process rather than integrating calibration dynamically with ongoing inspection operations, limiting their ability to adapt to changing conditions and reducing overall measurement accuracy during extended inspection sessions. As environmental conditions change throughout the day due to lighting variations, temperature effects, or weather conditions, and as equipment gradually shifts due to thermal expansion, mechanical vibration, or normal wear, static calibration becomes less accurate over time, yet conventional systems provide no mechanism for detecting or correcting this degradation without manual intervention.

Additionally, conventional tire-based approaches lack methods for automatically extracting accurate tire specification data required for reliable calibration calculations. Manual entry of tire specifications introduces potential human errors and operational inefficiencies, while simple optical character recognition systems often fail under challenging imaging conditions or with varied tire text formats across different manufacturers and tire types.

There exists a compelling need for an improved automatic scale calibration system that addresses these technical limitations while providing robust, accurate, and real-time calibration capabilities suitable for demanding vehicle inspection applications where measurement precision directly impacts safety assessments, quality control decisions, and regulatory compliance requirements.

The technical challenges described above have profound commercial implications across multiple industry sectors where vehicle condition assessment directly impacts financial decisions, regulatory compliance, and operational efficiency. The vehicle inspection market encompasses diverse applications including automotive insurance claim processing, used vehicle sales and auctions, fleet management operations, rental car condition assessment, regulatory safety inspections, and international trade documentation, collectively representing billions of dollars in annual economic activity where measurement accuracy directly affects commercial outcomes.

Automotive insurance companies process millions of vehicle damage claims annually, with each manual inspection requiring skilled adjuster time costing hundreds of dollars while creating customer delays that impact satisfaction and retention. Current manual inspection approaches typically require 30-45 minutes of technician time per vehicle, creating operational bottlenecks that limit facility throughput while introducing subjective variability in damage assessment that can lead to disputes, litigation, and inconsistent claim resolution. The economic impact of these limitations compounds across the industry, where small improvements in inspection speed, accuracy, and consistency translate to substantial operational cost reductions and competitive advantages.

Used vehicle sales operations face similar challenges where precise damage assessment directly impacts vehicle valuation decisions that can vary by thousands of dollars based on whether defects are classified as minor, moderate, or severe damage. Dealers, auction houses, and fleet operators require objective, defensible measurements to support pricing decisions, warranty determinations, and asset management strategies. The lack of consistent, automated measurement capabilities forces reliance on subjective human judgment that varies between appraisers and creates vulnerability to disputes that can result in significant financial exposure.

Fleet management operations for rental car companies, delivery services, transportation firms, and government agencies must regularly inspect thousands of vehicles for damage assessment, maintenance scheduling, and regulatory compliance documentation. Current manual approaches create operational inefficiencies that limit inspection frequency while failing to provide the systematic data collection necessary for predictive maintenance, asset optimization, and regulatory reporting requirements. The scale of these operations amplifies the economic impact of inspection limitations, where throughput improvements and labor cost reductions can generate millions of dollars in annual operational savings.

Regulatory and compliance applications increasingly require objective, traceable vehicle condition measurements for emissions testing certification, safety inspection documentation, and international trade verification. State inspection programs, federal compliance audits, and customs documentation processes demand reliable measurement data that meets legal defensibility standards while supporting efficient processing of high vehicle volumes. The growing emphasis on data-driven regulatory compliance creates compelling commercial drivers for automated measurement systems that provide consistent, documented results across diverse operating environments.

In accordance with certain aspects of the presently disclosed subject matter, there is provided a computerized system for calibrating vehicle part measurements that solves the technical problems described above through several coordinated innovations that work together synergistically to achieve superior calibration accuracy and reliability under real-world operating conditions.

The system comprises an interface configured for obtaining images of vehicle tires within an inspection area using imaging devices, and one or more processors configured to perform advanced calibration operations that overcome the fundamental limitations of conventional approaches through systematic application of multiple complementary technical innovations.

The processors automatically determine estimated tire size data from tire images using sophisticated computer vision techniques specifically designed to extract accurate dimensional information even under challenging visual conditions. The size determination process intelligently analyzes tire geometry through multiple coordinated techniques including automated tire boundary detection, consensus-based shape fitting algorithms, and advanced geometric analysis that provides robust performance despite image noise, surface contamination, or partial occlusions.

The system determines scale calibration data informative of pixels to physical unit ratio based on the estimated tire size data and actual tire size data, enabling the system to calibrate measurement calculations for objects of interest within images acquired by the imaging device while the vehicle is within the inspection area.

Optionally, the system implements pressure-invariant calibration techniques by calculating tire dimensional measurements along axes that remain substantially constant despite tire pressure variations. A particularly advantageous approach involves measuring horizontal tire diameter data, where the horizontal measurement provides calibration that remains substantially constant despite tire pressure variations that would cause significant errors in conventional vertical measurement approaches.

Optionally, the system detects and compensates for geometric distortions between imaging device planes and tire planes through sophisticated geometric analysis that maintains measurement accuracy even when perfect alignment cannot be achieved due to practical deployment constraints. The system fits ellipses to tire portions, particularly rim sections that provide consistent circular reference geometry, and analyzes ellipse characteristics to calculate angular misalignment between camera and tire planes.

Optionally, the automatic tire analysis process employs consensus-based estimation techniques, particularly RANSAC algorithms specifically adapted for tire boundary detection applications that provide superior performance compared to conventional edge detection approaches.

Optionally, advanced embodiments integrate sophisticated optical character recognition techniques specifically optimized for tire sidewall text recognition to automatically extract actual tire size data from tire specification markings.

The system performs calibration continuously while vehicles move through inspection areas, providing real-time scale calibration updates for dynamic vehicle inspection operations that maintain accuracy throughout extended inspection sessions.

As used herein, “scale calibration data” refers to mathematical conversion factors that establish the relationship between pixel dimensions in digital images and corresponding physical dimensions expressed in standard measurement units such as millimeters, inches, or other length units, enabling accurate translation from image-based measurements to real-world dimensional values.

As used herein, “estimated tire size data” refers to dimensional measurements of tire geometry derived directly from image analysis using computer vision techniques, including but not limited to tire diameter measurements, circumferential dimensions, or other geometric characteristics extracted through automated image processing without reliance on external dimensional references or manual measurement procedures.

As used herein, “actual tire size data” refers to ground truth dimensional specifications of tire geometry obtained from authoritative sources such as tire sidewall markings, manufacturer specifications, industry databases, or other reliable sources that provide independently verified dimensional information serving as reference standards for calibration calculations.

As used herein, “consensus-based estimation” refers to computational algorithms that determine optimal geometric parameters by evaluating agreement among multiple data points while systematically excluding outlier points that deviate significantly from the consensus pattern, providing robust parameter estimation despite the presence of noise, corruption, or partial data loss in the input dataset.

As used herein, “RANSAC” refers to the Random Sample Consensus algorithm, which is a specific implementation of consensus-based estimation that iteratively selects random subsets of data points to generate candidate models, evaluates how well each candidate model fits the remaining data points, and selects the model with maximum consensus as the optimal solution while automatically excluding outlier points.

As used herein, “tilt angle” refers to the angular deviation between an imaging device plane and a tire plane when these planes are not perfectly parallel, creating perspective distortion in captured images that affects the apparent geometry of circular tire features and requires mathematical compensation to maintain measurement accuracy.

As used herein, “geometric distortion” refers to systematic alterations in the apparent shape, size, or proportional relationships of objects in captured images resulting from perspective effects, angular misalignments, lens characteristics, or other factors that cause image geometry to deviate from true physical geometry, requiring computational correction for accurate dimensional analysis.

As used herein, “homographic transformation” refers to a mathematical technique for correcting perspective distortion through matrix-based coordinate transformations that map distorted image coordinates to corrected coordinates representing equivalent measurements under ideal geometric conditions, enabling accurate dimensional analysis despite angular misalignments or perspective effects.

As used herein, “pressure-invariant calibration” refers to measurement techniques that maintain consistent accuracy despite variations in tire inflation pressure by selecting measurement axes or geometric characteristics that remain substantially unchanged when tire pressure fluctuates due to temperature effects, slow leaks, or other operational factors that commonly affect tire geometry.

As used herein, “real-time calibration” refers to continuous calibration updating that occurs simultaneously with ongoing inspection operations, enabling adaptive refinement of calibration parameters throughout extended inspection sessions without requiring separate calibration procedures or operational interruptions that would reduce inspection throughput.

As used herein, “objects of interest” refers to vehicle components, features, or defects that require dimensional measurement during inspection operations, including but not limited to body panels, paint defects, dents, scratches, mechanical components, wear patterns, damage areas, or any other features for which accurate physical dimensions are necessary for assessment, classification, or decision-making purposes.

As used herein, “tire contour boundaries” refers to the detected edges or boundary lines that delineate the visible perimeter of tire features in digital images, including outer tire circumferences, inner rim boundaries, sidewall edges, or other geometric boundaries that define tire shape characteristics suitable for dimensional analysis and geometric parameter extraction.

As used herein, “defect severity classification” refers to the systematic categorization of identified vehicle defects into predetermined severity levels based on measured physical dimensions, defect characteristics, location factors, and established criteria, enabling automated decision-making regarding appropriate response actions ranging from continued monitoring to immediate repair recommendations.

As used herein, “pixels to physical unit ratio” refers to the mathematical relationship expressing how many pixels in a digital image correspond to a specific physical distance in real-world units, providing the fundamental conversion factor necessary for translating image-based measurements into accurate physical dimensions for engineering analysis and decision-making purposes.

As used herein, “consensus-based tire segmentation” refers to the application

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

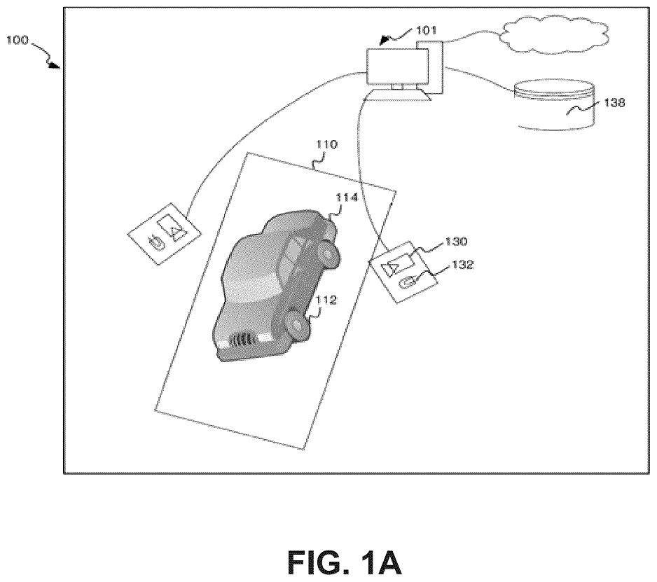

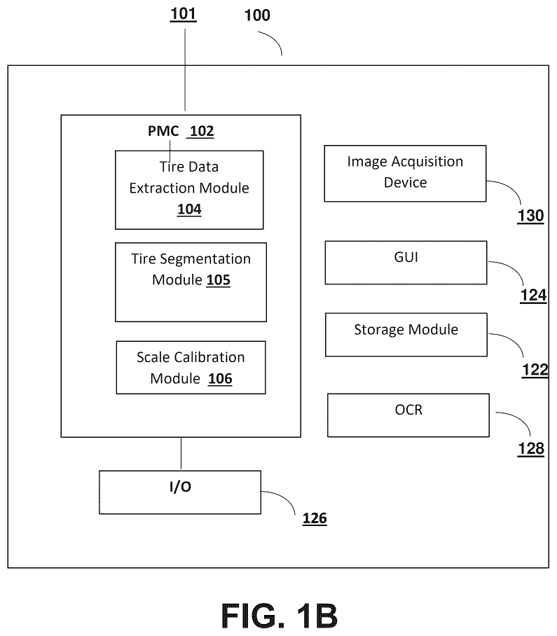

Referring to FIG. 1A, there is illustrated a vehicle inspection system 100 incorporating tire-based scale calibration that represents a fundamental advancement over conventional calibration approaches through the systematic integration of multiple technical innovations. The system 100 comprises a computerized calibration system 101 configured for determining accurate scale calibration data from tire-based measurements and applying that calibration to measure objects of interest in vehicle images with precision that enables reliable defect detection, severity assessment, and quality control decisions.

The inspection area 110 represents a defined spatial region where vehicles are positioned or pass through during inspection operations, accommodating both stationary inspection scenarios where vehicles are parked for comprehensive analysis and dynamic inspection scenarios where vehicles move at controlled speeds while inspection operations are performed continuously. Vehicle 114 with tire 112 is positioned within or passes through inspection area 110 during the calibration and measurement process, with the system accommodating various vehicle types including passenger cars, commercial trucks, motorcycles, buses, agricultural equipment, construction vehicles, and specialized transport vehicles.

Imaging device 130 comprises sophisticated digital camera equipment with high-resolution CCD or CMOS sensors capable of capturing images with sufficient resolution and quality to enable both accurate tire text recognition and precise boundary detection required for reliable calibration calculations. The imaging device 130 mounts on supporting structures such as poles, arcs, or overhead gantries positioned to capture clear images of vehicle tires throughout the inspection process while maintaining sufficient distance to avoid perspective distortion that could affect measurement accuracy.

Optionally, illumination device 132 provides consistent, uniform lighting across the imaging device's field of view to ensure high-quality image capture under varying ambient lighting conditions that could otherwise affect tire text recognition accuracy and boundary detection precision. The illumination system may comprise LED arrays specifically selected for optimal spectral characteristics, halogen lamps with appropriate diffusion systems, or other suitable lighting technologies.

Optionally, advanced illumination systems may incorporate multiple wavelengths optimized for different aspects of the image processing pipeline, polarization control to enhance contrast between tire text and rubber backgrounds while reducing specular reflections, and adaptive intensity control that adjusts illumination based on ambient lighting conditions.

Referring to FIG. 1B, the computerized calibration system 101 comprises processing and memory circuitry (PMC) 102 that provides the sophisticated computational processing necessary for implementing the advanced calibration algorithms described herein, including real-time image processing, consensus-based shape fitting, geometric distortion calculation and compensation, and continuous calibration updating capabilities.

The PMC 102 operatively connects to hardware-based input/output interface 126 and storage unit 122 to create an integrated processing environment capable of handling the demanding computational requirements of real-time geometric analysis, mathematical transformation calculations, and continuous calibration updates while maintaining inspection throughput suitable for high-volume commercial applications. Optionally, PMC 102 comprises one or more processors configured to execute several functional modules implemented as computer-readable instructions stored on non-transitory computer-readable memory, with the processor architecture potentially including general-purpose microprocessors optimized for sequential processing tasks, specialized digital signal processors designed for intensive mathematical operations, graphics processing units that excel at parallel image processing algorithms, field-programmable gate arrays that can be customized for specific algorithmic implementations, and application-specific integrated circuits designed for optimal performance of particular computational tasks.

The functional modules comprised in PMC 102 include tire data extraction module 104 operating in sophisticated coordination with OCR module 128 for automated tire text recognition, tire segmentation module 105 implementing consensus-based boundary detection algorithms specifically adapted for tire geometry, scale calibration module 106 with advanced measurement capabilities and integrated geometric compensation, and tilt compensation module 214 that provides comprehensive geometric distortion analysis and correction capabilities.

Optionally, the graphical user interface (GUI) 124 provides comprehensive visualization capabilities for monitoring calibration performance, displaying geometric analysis results, showing real-time calibration parameter trends, and enabling system configuration for specialized inspection requirements or facility-specific optimization.

Tire data extraction module 104 implements sophisticated optical character recognition algorithms specifically optimized for extracting tire sidewall text under challenging visual conditions that commonly occur in real-world inspection environments, including various text orientations resulting from tire positioning constraints, font variations across different tire manufacturers and product lines, partial occlusions caused by dirt accumulation, wear patterns, or surface contamination, and lighting variations from natural and artificial sources.

Optionally, the module handles diverse tire text formats including passenger car designations, commercial truck specifications, motorcycle tire markings, and specialized vehicle tire identification systems through machine learning algorithms trained on extensive databases of tire text examples that enable reliable character recognition across diverse tire types, manufacturers, and conditions.

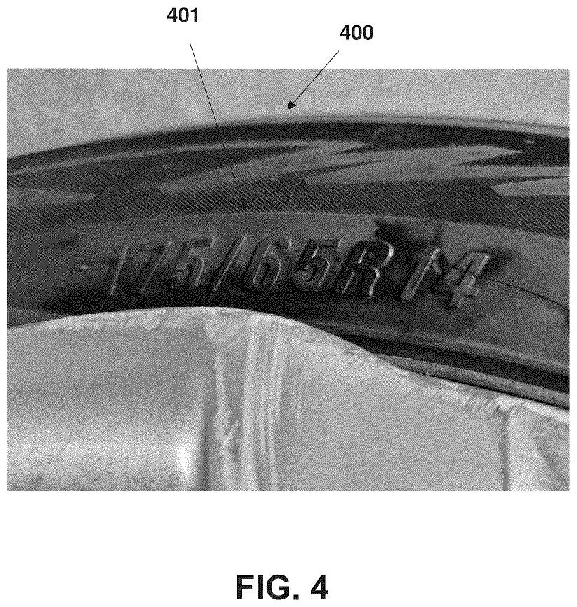

Referring to FIG. 4, there is illustrated an exemplary tire image segment that demonstrates the automatic text extraction capabilities essential for determining actual tire size data. The tire image shows tire 400 with sidewall text data 401 formatted according to established industry standard conventions that provide comprehensive dimensional information required for accurate calibration calculations.

Optionally, the tire text data 401 typically follows standardized formats such as XXX/YYRZZ for passenger vehicles, where XXX represents tire width expressed in millimeters, YY represents aspect ratio expressed as a percentage of tire width, R indicates radial construction methodology, and ZZ represents rim diameter expressed in inches according to established tire industry standards.

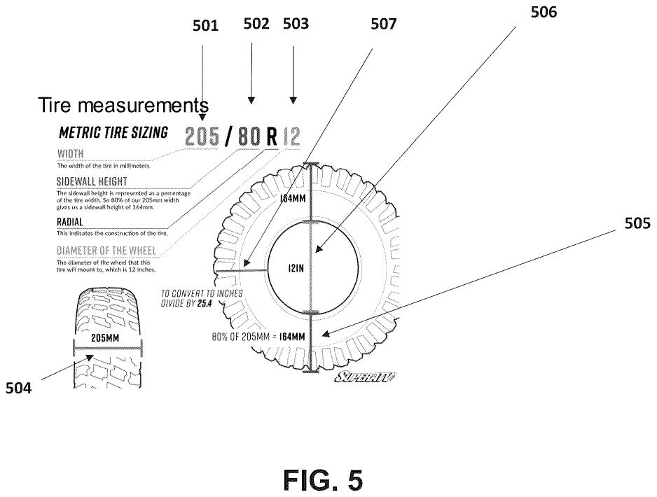

FIG. 5 illustrates the mathematical relationships for converting tire specification text into actual tire diameter data expressed in consistent length units. Tire width 504 in millimeters provides the basis for calculating sidewall height 505, which equals the tire width multiplied by the aspect ratio percentage divided by one hundred. The overall tire diameter calculation follows the established relationship: Overall Tire Diameter=((Tire Width×Aspect Ratio)/100)×2+(Rim Diameter×25.4), where the factor 25.4 converts inches to millimeters for dimensional consistency.

Optionally, the recognition algorithms incorporate sophisticated preprocessing techniques that enhance text visibility, geometric correction algorithms that compensate for text orientation variations, and statistical validation methods that ensure extraction accuracy even under challenging visual conditions.

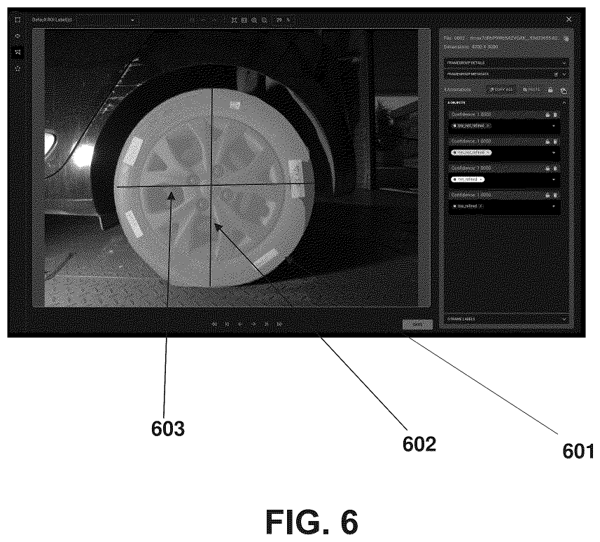

FIG. 6 illustrates the sophisticated image processing techniques implemented by tire segmentation module 105 for accurate tire boundary detection and geometric analysis. The segmentation process represents a significant advancement over conventional edge detection approaches through the systematic application of consensus-based algorithms that provide robust performance under challenging real-world imaging conditions.

The segmentation process begins by converting tire images into coordinate point sets representing potential tire boundary locations using sophisticated gradient-based edge detection algorithms that identify regions of significant intensity change corresponding to tire edges while filtering electronic noise, lighting variations, and irrelevant features. These initial edge detection algorithms employ multi-scale analysis techniques that detect edges at different resolution levels, adaptive thresholding methods that adjust sensitivity based on local image characteristics, and morphological processing operations that enhance edge continuity while removing spurious noise artifacts.

Optionally, the consensus-based refinement process applies RANSAC algorithms specifically adapted for tire shape fitting applications, representing a fundamental improvement over conventional least-squares fitting approaches that are sensitive to outlier points resulting from image noise, surface contamination, or partial occlusions.

The RANSAC algorithm iteratively performs several coordinated operations that work together to identify optimal geometric parameters while systematically excluding corrupted data points. The algorithm randomly selects minimal subsets of boundary points from the detected edge point set, ensuring statistical independence of sample selections through sophisticated random sampling techniques. For each selected subset, the algorithm calculates parameters of a candidate geometric shape that best fits the selected points using standard geometric fitting equations adapted for numerical stability.

Optionally, the consensus evaluation process represents a critical innovation that distinguishes this approach from conventional fitting methods by naturally excluding outlier points that could result from image noise, surface contamination, or partial occlusions while identifying geometric parameters that best represent true tire boundary geometry.

FIG. 6 shows the results of this segmentation process, with horizontal diameter measurement 602 and vertical diameter measurement 604 extracted from the processed tire image, providing the foundation for both robust dimensional measurement and geometric distortion detection capabilities.

Optionally, the system implements specific measurement techniques that provide enhanced accuracy and reliability for calibration applications. One particularly advantageous approach involves measuring tire dimensions along axes that remain substantially constant despite operational variations that commonly affect tire geometry. This pressure-invariant measurement technique addresses a critical limitation of conventional tire-based calibration approaches that experience accuracy degradation when tire pressure varies due to temperature changes, slow leaks, or normal operational factors.

The horizontal measurement approach represents an optional embodiment that leverages tire structural characteristics to achieve superior calibration stability compared to conventional approaches. When tire pressure decreases, vehicle weight causes vertical compression of tire sidewalls due to gravitational loading, significantly affecting vertical dimensional measurements. However, tire structural design provides sufficient lateral stiffness to maintain horizontal dimensions substantially unchanged during pressure variations.

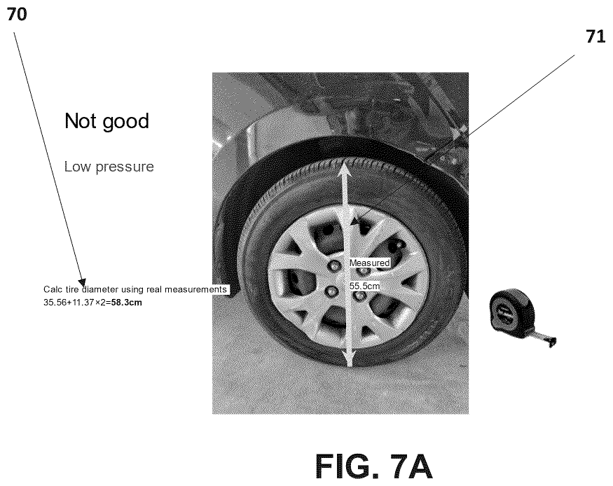

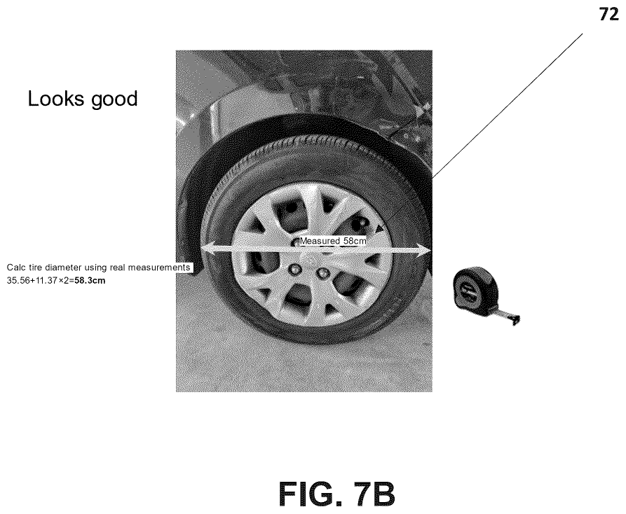

FIGS. 7A-B present comprehensive experimental validation of the tire-based calibration methodology through controlled laboratory testing. FIG. 7A shows tire performance under normal operational conditions with measured vertical diameter of 58.3 centimeters and horizontal diameter of 58.3 centimeters, confirming baseline measurement accuracy under ideal conditions. FIG. 7B shows the same tire after controlled pressure reduction, with vertical diameter measuring 55.5 centimeters due to sidewall compression under vehicle weight loading, while horizontal diameter maintains 58.0 centimeters despite identical pressure reduction conditions.

The experimental results demonstrate vertical measurement variation of approximately five percent due to pressure effects, while horizontal measurement variation remains within one percent despite identical pressure reduction conditions, providing clear quantitative validation of the horizontal measurement approach's substantial superiority for calibration applications.

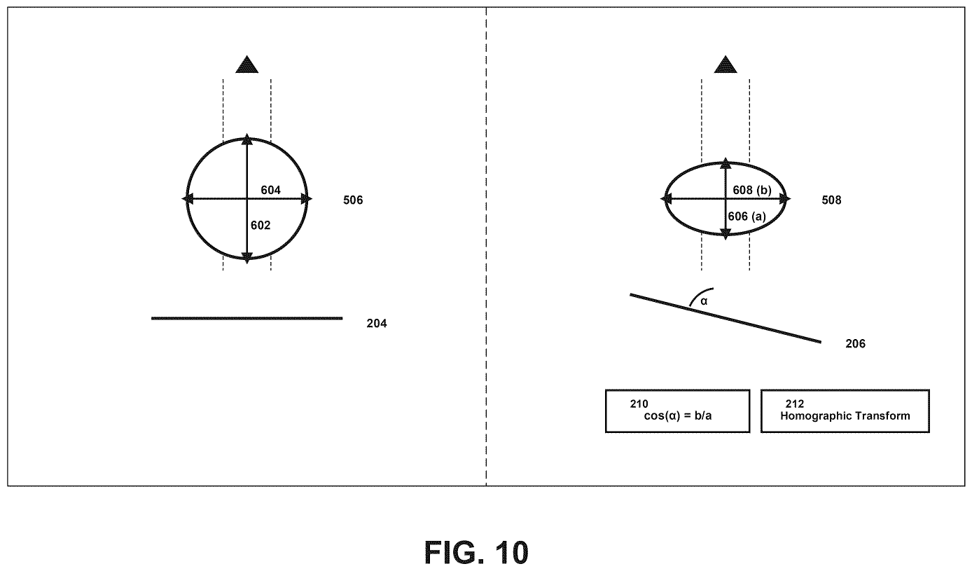

FIG. 10 provides comprehensive illustration of the geometric analysis system that enables accurate calibration when imaging device 130 and tire 112 are not positioned in perfect parallel alignment. This capability represents a significant technical advancement that enables practical deployment in inspection facilities where perfect camera-tire alignment cannot be achieved or maintained consistently.

The left portion of FIG. 10 illustrates the ideal geometric scenario where camera plane 202 and tire plane 204 maintain substantially parallel orientation, creating imaging conditions where tire rim 506 appears as a substantially perfect circle when captured by imaging device 130. Under these ideal conditions, horizontal diameter measurement 602 and vertical diameter measurement 604 yield substantially equivalent dimensional values, indicating absence of significant perspective distortion.

The right portion of FIG. 10 illustrates the more common real-world deployment scenario where camera plane 202 and tilted tire plane 206 exhibit relative tilt angle α due to vehicle positioning variations, camera mounting constraints, or facility layout limitations. This geometric misalignment causes tire rim 508 to appear as an elliptical shape in the captured image due to perspective projection effects that fundamentally alter the relationship between horizontal and vertical dimensional measurements.

Tilt compensation module 214 implements sophisticated ellipse fitting algorithms specifically designed to detect and characterize perspective distortion effects through detailed analysis of tire rim boundary coordinates extracted by tire segmentation module 105. The module fits optimal ellipses to detected rim boundaries using mathematical optimization techniques that determine ellipse parameters including major axis measurement 606 and minor axis measurement 608 that quantify the geometric distortion resulting from angular misalignment.

Mathematical relationship 210 provides the algorithmic foundation for precise angular misalignment determination using the geometric relationship cos(α)=b/a, where α represents the tilt angle between camera plane 202 and tilted tire plane 206, ‘a’ represents major axis length 606, and ‘b’ represents minor axis length 608.

Optionally, when the calculated tilt angle α exceeds predetermined threshold values, typically ranging from five to ten degrees depending upon accuracy requirements and operational tolerances, tilt compensation module 214 implements homographic transformation 212 to compensate for perspective distortion effects in subsequent calibration calculations.

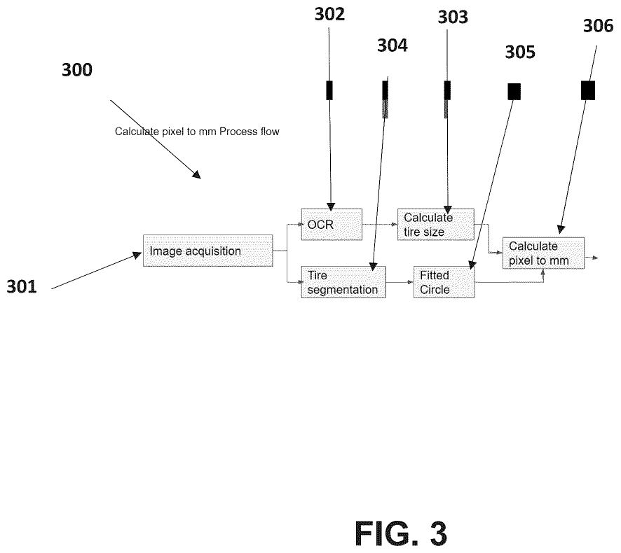

FIG. 3 illustrates the generalized flow diagram of operations for determining pixels to length unit transformation with consensus-based tire segmentation and integrated geometric compensation capabilities. The operational workflow begins when imaging device 130 captures images of tire 112 positioned within inspection area 110, with image data transmitted to PMC 102 through hardware-based I/O interface 126.

The processing flow includes automatic tire boundary detection using consensus-based algorithms, geometric analysis for distortion detection, tire text extraction using OCR module 128, scale calibration calculation or updating by scale calibration module 106, and optional geometric compensation by tilt compensation module 214 when angular misalignment is detected.

Optionally, the continuous calibration approach provides several significant advantages over conventional static calibration methods. The system adapts to gradual changes in imaging conditions such as lighting variations from changing weather conditions, camera thermal drift from equipment warming during extended operation periods, and mechanical vibrations that can affect camera positioning over time.

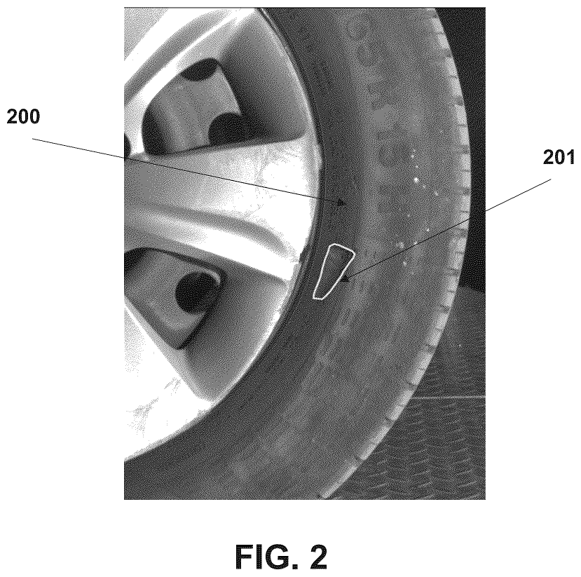

FIG. 2 illustrates an exemplary application of the calibrated measurement system for comprehensive defect detection and severity assessment. The figure shows tire 200 with identified defect 201 such as a crack, dent, puncture, or irregular wear pattern that requires precise dimensional analysis to determine appropriate response actions.

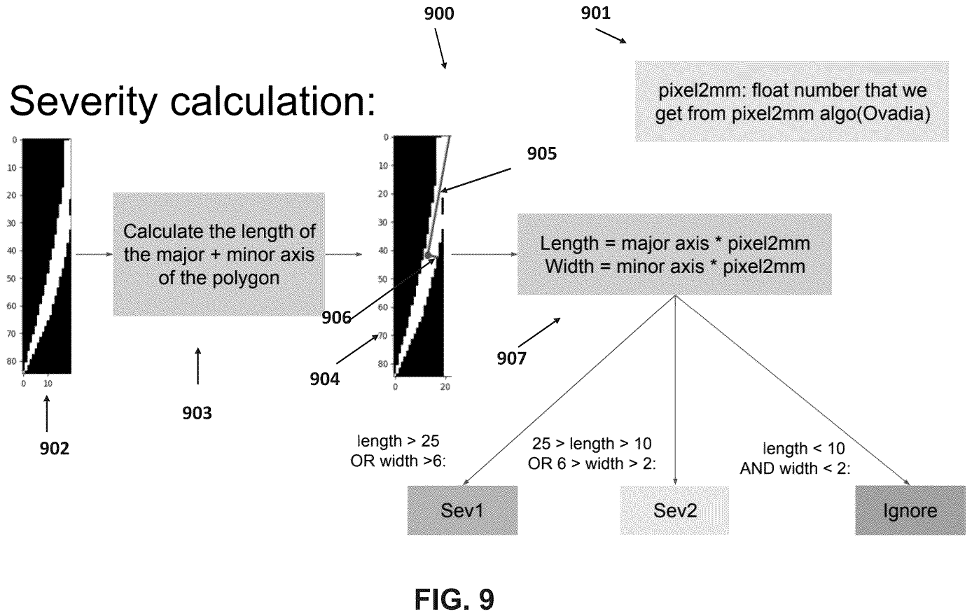

FIG. 9 demonstrates the integrated workflow for comprehensive defect severity classification using calibrated measurements. The process begins with extraction of scale calibration data 901 from storage unit 122, representing the pixels to length unit conversion factors determined through the tire-based calibration methodology with geometric compensation applied when necessary.

Defect detection 902 employs advanced computer vision algorithms trained for various defect types commonly encountered in vehicle inspection applications. Defect size determination 903 employs sophisticated polygon analysis 904 to characterize irregular defect geometries through mathematical analysis that captures essential dimensional characteristics including major axis 905 and minor axis 906 measurements.

Optionally, pixel-based defect measurements are converted to physical units using the calibration data through mathematical operations that preserve measurement accuracy while accounting for any geometric corrections applied during the calibration process.

Optionally, severity classification compares converted physical dimensions against predetermined threshold criteria to categorize defects into severity classes such as “minor,” “moderate,” “severe,” or “critical” based on defect size characteristics, location on the vehicle, defect type considerations, and relevant industry standards.

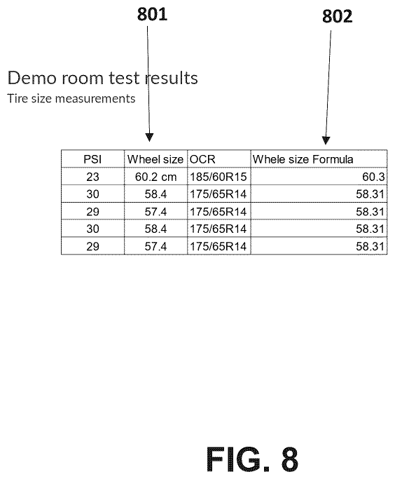

FIG. 8 provides comprehensive validation results comparing actual tire diameters measured using precision mechanical calipers as ground truth references with calculated diameters determined using the described calibration methodology across various test scenarios. The validation testing encompasses different tire sizes from passenger vehicles to commercial trucks, various pressure levels from fully inflated to significantly under-inflated conditions, diverse imaging conditions including different lighting angles and intensities, and tire conditions ranging from new tires with pristine sidewall text to worn tires with degraded surface characteristics.

The tabulated results demonstrate calibration accuracy consistently within two percent of actual dimensions across all tested scenarios, representing significant improvement over conventional approaches that may exhibit five to ten percent accuracy degradation under challenging conditions commonly encountered in real-world inspection environments.

Storage unit 122 maintains comprehensive databases of calibration parameters, geometric compensation data, performance metrics, and historical trend information to support both real-time processing and long-term system optimization capabilities. The data management includes statistical analysis of calibration consistency, detection of systematic changes that might indicate equipment drift or environmental modifications, and performance monitoring that enables predictive maintenance scheduling. Optionally, the system accommodates various vehicle types, tire sizes, and operational configurations through algorithmic adaptations that maintain optimal performance across diverse deployment scenarios without requiring manual reconfiguration or specialized setup procedures.

It is expected that during the life of a patent maturing from this application many relevant methods and systems will be developed and the scope of the term image sensor, camera, and processor is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computerized system for calibrating vehicle part measurements, comprising:
an interface configured for obtaining an image of a vehicle's tire within an inspection area using an imaging device;
one or more processors configured for: determining estimated tire size data from the tire image;
determining scale calibration data informative of pixels to physical unit ratio, based on said estimated tire size data and actual tire size data; and
utilizing at least the scale calibration data to calibrate measurement calculations for objects of interest within images acquired by said imaging device while the vehicle is within said inspection area.

2. A computerized system for pressure-invariant vehicle measurement calibration, comprising:
an imaging device configured for capturing tire images within an inspection area;
one or more processors configured for: measuring tire dimensional data along horizontal axes that remain substantially constant despite tire pressure variations;
calculating scale calibration factors based on said horizontal tire measurements, wherein horizontal measurements maintain accuracy within 2% despite tire pressure variations exceeding 25% of manufacturer specifications;
determining scale calibration data informative of pixels to physical unit ratio using said pressure-invariant measurements; and
applying said scale calibration data to calibrate measurements of objects of interest.

3. A computerized system for geometric distortion compensation in vehicle calibration, comprising: an imaging device positioned to capture tire images; one or more processors configured for: detecting geometric distortion in tire images resulting from angular misalignment between imaging device plane and tire plane; fitting ellipses to tire rim portions in captured images; calculating angular misalignment using the relationship cos(α)=b/a, where α is tilt angle, ‘a’ is ellipse major axis length, and ‘b’ is ellipse minor axis length; applying homographic transformation to correct perspective distortion when calculated tilt angle exceeds a predetermined threshold; and determining calibration data using geometrically corrected tire measurements.

4. A computerized method for continuous vehicle calibration updating, comprising: capturing tire images from vehicles moving through an inspection area; extracting tire dimensional measurements from each image using consensus-based boundary detection algorithms; calculating updated scale calibration factors for each processed vehicle; performing real-time calibration updates during dynamic vehicle inspection operations; statistically combining calibration factors from multiple vehicles to improve accuracy over time; and adapting calibration parameters to changing environmental conditions and equipment drift.

5. The system of claim 1, wherein determining the estimated tire size data comprises: automatically segmenting the tire image to identify tire contour boundaries using gradient-based edge detection algorithms; applying consensus-based estimation techniques to fit geometric shapes to segmented tire boundaries while excluding outlier points resulting from image noise or surface contamination; and calculating tire dimensional measurements from fitted geometric shapes.

6. The system of claim 5, wherein the consensus-based estimation technique comprises a RANSAC algorithm that iteratively selects random subsets of boundary points, fits candidate geometric shapes to each subset, evaluates consensus among remaining points for each candidate shape, and selects optimal geometric parameters based on maximum consensus criteria.

7. The system of claim 1, wherein the processors are further configured for: extracting tire specification text from the tire image using optical character recognition techniques optimized for tire sidewall text recognition; parsing tire designation format including tire width, aspect ratio, and rim diameter parameters; calculating the actual tire size data from extracted tire specification text using mathematical relationships that convert tire specification parameters into overall tire dimensional data.

8. The system of claim 7, wherein calculating the actual tire size data comprises applying the relationship: Overall Tire Diameter=((Tire Width×Aspect Ratio)/100)×2+(Rim Diameter×25.4), where the factor 25.4 converts inches to millimeters for dimensional consistency.

9. The system of claim 2, wherein the pressure-invariant calibration leverages tire structural characteristics that provide lateral stiffness maintaining horizontal dimensions substantially unchanged while allowing vertical compliance under vehicle weight loading, wherein tire pressure loss primarily affects vertical tire compression due to vehicle weight while horizontal tire dimensions remain substantially unchanged due to tire structural design characteristics.

10. The system of claim 3, wherein the predetermined threshold for activating geometric compensation is tilt angle exceeding 5 degrees, corresponding to ellipse eccentricity exceeding 0.1 or major axis to minor axis ratio exceeding 1.15.

11. The system of claim 3, wherein the ellipse fitting process employs least-squares optimization algorithms specifically adapted for rim geometry characteristics to determine ellipse parameters that best fit detected rim boundary points while accounting for rigid metal construction providing sharper edge characteristics compared to tire sidewall boundaries.

12. The method of claim 4, wherein the consensus-based boundary detection employs RANSAC algorithm with 500-1000 iterations and distance thresholds of 2-5 pixels for boundary point consensus evaluation, with early termination criteria when consensus quality exceeds specified thresholds.

13. The system of claim 1, wherein the processors are configured to: process multiple tire images from different vehicles within the inspection area; generate statistical calibration data based on multiple tire measurements using weighted averaging algorithms that balance responsiveness with measurement consistency; apply statistical refinement to improve overall calibration reliability while maintaining statistical stability.

14. The system of claim 1, wherein utilizing the scale calibration data comprises: identifying defects in vehicle images using computer vision algorithms trained for various defect types; measuring defect dimensions using polygon analysis that characterizes irregular defect geometries; converting pixel-based measurements to physical unit measurements using the scale calibration data; comparing measured defect dimensions against predetermined severity thresholds; classifying defects into severity categories based on actual physical dimensions.

15. The system of claim 14, wherein the polygon analysis determines major axis and minor axis measurements that accurately represent defect extent in different dimensional orientations, enabling precise severity assessment that accounts for defect geometry complexity and orientation characteristics.

16. The system of claim 1, wherein the objects of interest comprise at least one of: vehicle body defects, paint damage, dents, scratches, tire wear patterns, mechanical component dimensions, rust formation, clearcoat damage, and punctures.

17. The system of claim 1, wherein the processors are configured to: adapt calibration parameters for different tire types including passenger vehicle tires, commercial truck tires, motorcycle tires, and specialized vehicle applications; automatically adjust measurement algorithms based on detected tire characteristics including tire size ranges from 400 mm to 1200 mm diameter; accommodate various tire designation systems through algorithmic adaptations that recognize different text formats.

18. The system of claim 1, wherein the imaging device comprises high-resolution CCD or CMOS sensors with illumination systems providing consistent lighting conditions, and wherein the system operates with processing latency under 100 milliseconds per tire image for high-throughput inspection applications.

19. The system of claim 1, wherein the processors comprise specialized processing architectures including at least one of: digital signal processors optimized for intensive mathematical operations, graphics processing units for parallel image processing algorithms, field-programmable gate arrays customized for specific algorithmic implementations, and application-specific integrated circuits designed for computer vision operations.

20. The system of claim 1, further comprising: a storage unit configured to maintain calibration databases, geometric compensation data, performance metrics, and historical trend information; a graphical user interface configured to display calibration performance monitoring, geometric analysis results, and real-time calibration parameter trends; hardware-based input/output interface connecting processing and memory circuitry to imaging devices and storage systems.

21. A computerized method for calibrating vehicle part measurements, comprising: obtaining an image of a vehicle's tire within an inspection area using an imaging device; determining estimated tire size data from the tire image using computer vision techniques; obtaining actual tire size data; calculating scale calibration data informative of pixels to physical unit ratio based on the estimated tire size data and the actual tire size data; and applying the scale calibration data to calibrate measurements of objects of interest in vehicle inspection images.

22. The method of claim 21, further comprising: detecting geometric distortion in the tire image resulting from angular misalignment between the imaging device and the tire; calculating compensation parameters to correct for the detected geometric distortion using ellipse fitting and tilt angle analysis; and applying the compensation parameters to the scale calibration data calculation using homographic transformation.

23. The method of claim 21, wherein determining the estimated tire size data comprises measuring tire dimensions along horizontal axes that provide calibration substantially invariant to tire pressure variations, wherein horizontal tire measurements remain substantially constant despite tire pressure changes due to tire structural characteristics.

24. The method of claim 21, further comprising: performing calibration continuously while vehicles move through the inspection area; providing real-time scale calibration updates during dynamic vehicle inspection operations; refining calibration parameters using measurements from multiple vehicles to improve calibration accuracy over time.

25. A non-transitory computer readable storage medium storing instructions that, when executed by a processor, cause the processor to perform the method of claim 21.
